(19) United States
(12) Patent Application Publication
(10) Pub. No.: US 2012/0054047 A1
(43) Pub. Date: Mar. 1, 2012

(54) COMMODITY SALES DATA PROCESSING APPARATUS, CASH DEPOSITING AND DISPENSING SYSTEM, AND DATA PROCESSING METHOD

(75) Inventor: Kikuo Hayashi, Shizuoka (JP)

(73) Assignee: TOSHIBA TEC KABUSHIKI KAISHA, Tokyo (JP)

(21) Appl. No.: 13/218,601

(22) Filed: Aug. 26, 2011

(30) Foreign Application Priority Data
Sep. 1, 2010 (JP) 2010-196144

(51) Int. Cl. G06Q 20/00

(52) U.S. Cl. 705/16

(57) ABSTRACT

According to one embodiment, a commodity sales data processing apparatus includes an acquiring section, a storing section, and a deposit-amount calculating section. The acquiring section acquires stored amount information concerning a total amount of money stored in a money depositing and dispensing machine. The storing section stores last-stored-amount information concerning a total amount of money in the money depositing and dispensing machine after the end of the last transaction. The deposit-amount calculating section calculates a deposit amount in the present transaction using the last-stored-amount information stored by the storing section and the stored amount information acquired by the acquiring section.

### CROSS-REFERENCE TO RELATED APPLICATION

This application is based upon and claims the benefit of priority from Japanese Patent Application No. 2010-196144 filed on Sep. 1, 2010; the entire contents of which are incorporated herein by reference.

### FILED

Embodiments described herein relate generally to a commodity sales data processing apparatus, a cash depositing and dispensing system, and a data processing method.

### BACKGROUND

In the past, a depositing and dispensing system including a POS terminal and a money depositing and dispensing machine is known. The cash depositing and dispensing system counts an amount of a deposit for commodities in one transaction with the money depositing and dispensing machine and uses the deposit amount for settlement processing in the POS terminal.

In such a cash depositing and dispensing system, first, the POS terminal calculates a total amount of commodities, commodity codes of which are input by the operation of a scanner or the like. Thereafter, if the POS terminal receives the operation of a counting start key, the POS terminal transmits a counting start command for instructing the start of counting of money to the money depositing and dispensing machine. After receiving the counting start command, the money depositing and dispensing machine starts counting of the numbers of deposited coins and bills. The money depositing and dispensing machine calculates a deposit amount on the basis of a counting result and transmits the calculated deposit amount to the POS terminal. The POS terminal performs settlement using the received deposit amount. Since the money depositing and dispensing machine counts a deposit for commodities in one transaction, such a cash depositing and dispensing system can accurately counts money compared with counting by a store clerk.

However, in the related art, since money deposited in the money depositing and dispensing machine after all commodity codes are input and a total amount of commodities are calculated by the POS terminal is used as a deposit amount, time required for a transaction is long.

### DESCRIPTION OF THE DRAWINGS

FIG. 1 is an external perspective view of a cash depositing and dispensing system according to an embodiment;

FIG. 2 is a block diagram of a POS terminal according to the embodiment;

FIG. 3 is a schematic diagram of a last-stored-amount-information storing area of a RAM of the POS terminal;

FIG. 4 is a diagram of a keyboard of the POS terminal;

FIG. 5 is a block diagram of the configuration of a money depositing and dispensing machine according to the embodiment;

FIG. 6 is a flowchart of cash depositing and dispensing processing executed by the money depositing and dispensing machine;

FIG. 7 is a block diagram of a functional configuration of the POS terminal in checkout processing according to the embodiment; and

FIG. 8 is a flowchart of processing executed by the POS terminal.

### DETAILED DESCRIPTION

In general, according to one embodiment, a commodity sales data processing apparatus includes an acquiring section, a storing section, and a deposit-amount calculating section. The acquiring section acquires stored amount information concerning a total amount of money stored in a money depositing and dispensing machine. The storing section stores last-stored-amount information concerning a total amount of money in the money depositing and dispensing machine after the end of the last transaction. The deposit-amount calculating section calculates a deposit amount in the present transaction using the last-stored-amount information stored by the storing section and the stored amount information acquired by the acquiring section.

A commodity sales data processing apparatus, a cash depositing and dispensing system, and a data processing method according to an embodiment are explained in detail below with reference to the accompanying drawings.

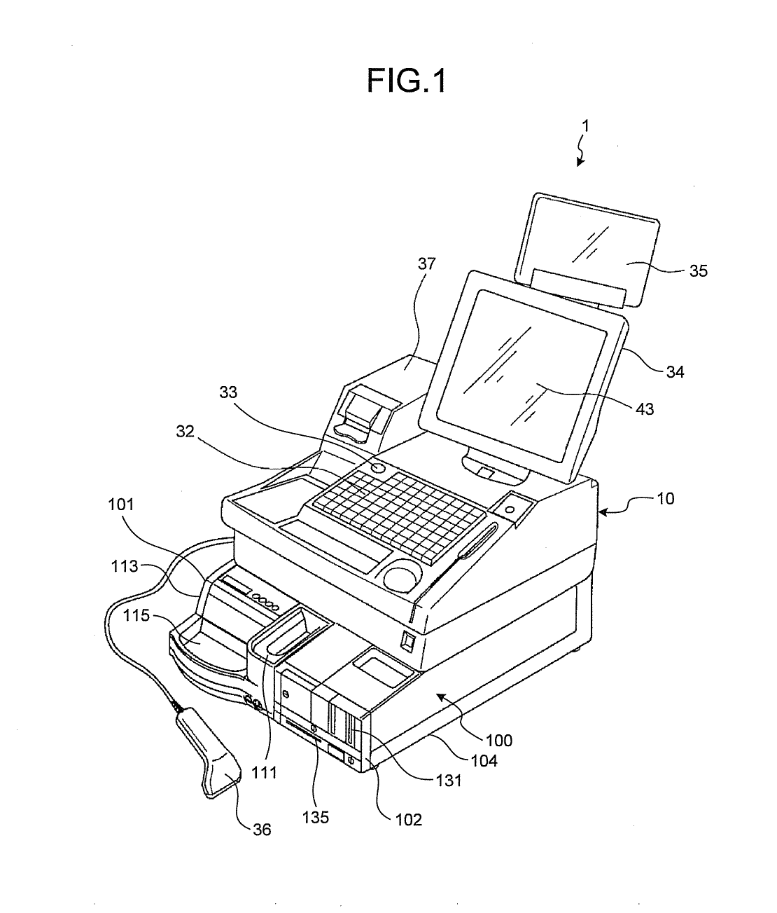

As shown in FIG. 1, the cash depositing and dispensing system 1 includes a POS (Point of Sales) terminal 10 and a money depositing and dispensing machine 100. The POS terminal 10 is a commodity sales data processing apparatus. The money depositing and dispensing machine 100 is connected to the POS terminal 10 via a communication cable (not shown).

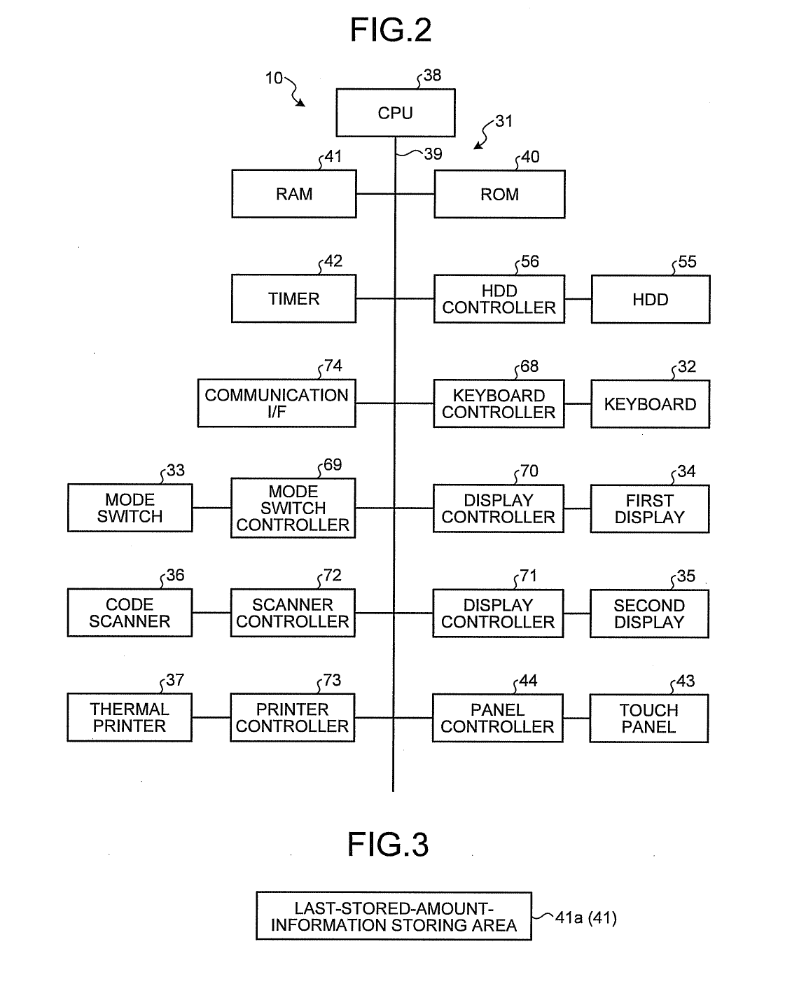

The POS terminal 10 includes a keyboard 32, a mode switch 33, a first display 34, a second display 35, a code scanner 36, and a thermal printer 37. The first display 34 is mainly a display for an operator. The second display 35 is mainly a display for a customer. A touch panel 43 is laminated on and attached to the first display 34. The touch panel 43 is an input device. The POS terminal 10 includes a control section 31 (see FIG. 2) configured to control these sections. The control section 31 is a computer.

As shown in FIG. 2, the control section 31 includes a CPU (Central Processing Unit) 38, an ROM (Read Only Memory) 40, an RAM (Random Access Memory) 41 functioning as a storing section, and a timer 42. The ROM 40, the RAM 41, and the timer 42 are connected to the CPU 38 via a bus line 39 such as an address bus or a data bus. The CPU 38 collectively controls the sections of the POS terminal 10. The ROM 40 has various computer programs and various data stored therein. The RAM 41 configures various buffers such as a sales buffer and a printing buffer and rewritably stores various data. The timer 42 measures date and time and the like.

As shown in FIG. 3, the RAM 41 includes a last-stored-amount-information storing area 41a. The last-stored-amount-information storing area 41a stores last-stored-amount information. The last-stored-amount information is the numbers of coins and bills by type in the money depositing and dispensing machine 100 after the end of the last transaction. When the POS terminal 10 is started, stored amount information of the money depositing and dispensing machine 100 during the start of the POS terminal 10 is stored in the last-stored-amount-information storing area 41a. The stored amount information may be a total amount of money in the money depositing and dispensing machine 100.

The sections controlled to be driven by the control section 31 are explained.

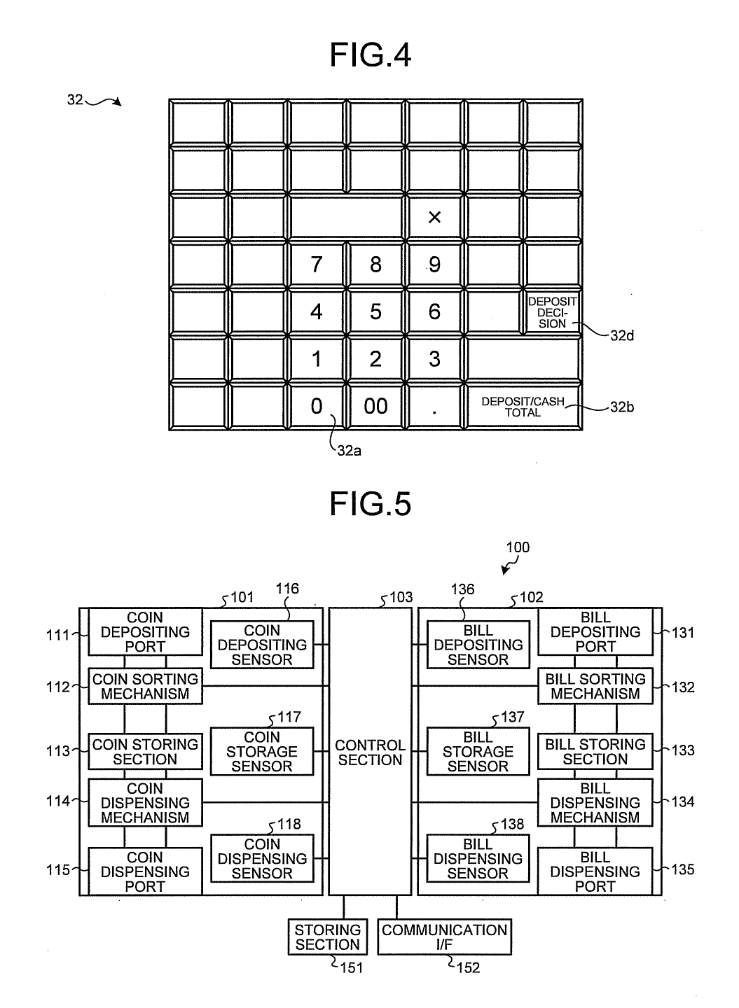

As shown in FIG. 4, the keyboard 32 includes various operation keys for receiving operation. The various operation keys include, for example, number keys 32a, a deposit/cash total key 32b, and a deposit decision key 32d. The deposit/cash total key 32b declares that a price of one transaction is settled by cash. The operation of the deposit/cash total key 32b is operation for triggering settlement. The deposit decision key 32d is a key for instructing transmission of a stored amount request command. The stored amount request command is request information for requesting stored amount information. The operation of the deposit decision key 32d is operation for triggering acquisition of stored amount information. In this embodiment, the keyboard 32 is equivalent to an operation section. The deposit decision key 32d is a first operation section and the deposit/cash total key 32b is a second operation section. The keyboard 32 is connected to the bus line 39 via a keyboard controller 68. The keyboard 32 inputs a signal corresponding to an operated operation key to the control section 31 according to the operation of the keyboard controller 68.

The mode switch 33 is connected to the bus line 39 via a mode switch controller 69. The mode switch 33 inputs a signal corresponding to a switching position to the control section 31 according to the operation of the mode switch controller 69. The control section 31 sets, according to an output signal from the mode switch 33, an operation mode of the POS terminal 10 to job modes such as a registration mode, a setting mode, a settlement mode, and an inspection mode. Switching of the operation mode of the POS terminal 10 is not limited to switching controlled by an output signal corresponding to a switching position of hardware, i.e., the mode switch 33. The switching of the operation mode of the POS terminal 10 may be performed by software for controlling the switching according to the operation of buttons, which indicate the operation modes displayed on a screen, by a pointing device such as a mouse.

The first display 34 and the second display 35 are connected to the bus line 39 via display controllers 70 and 71. If display data from the control section 31 is input to the display controllers 70 and 71, the first display 34 and the second display 35 are driven by the display controllers 70 and 71 and display predetermined matters.

The touch panel 43 recognizes the position of an XY coordinate on a panel touched by an operator and acquires a coordinate data. The touch panel 43 is connected to the bus line 39 via the panel controller 44. The touch panel 43 inputs a signal corresponding to the acquired coordinate data to the control section 31 according to the operation of the panel controller 44.

The code scanner 36 optically reads a commodity code such as a barcode affixed to a commodity. The code scanner 36 is connected to the bus line 39 via the scanner controller 72. The code scanner 36 transmits data of the read commodity code to the control section 31 according to the operation of the scanner controller 72.

The thermal printer 37 is connected to the bus line 39 via the printer controller 73. The terminal printer 37 is controlled to be driven by the control section 31. The thermal printer 37 includes a cutter section (not shown). The thermal printer 37 is controlled to be driven by the control section 31, prints matters necessary for a receipt on a not-shown receipt sheet, which is elongated paper, cuts the printed receipt sheet, and issues the cut receipt sheet as a receipt.

A communication interface 74 is connected to the CPU 38 via the bus line 39. The communication interface 74 is connected to the money depositing and dispensing machine 100 via a communication cable. The communication interface 74 manages data communication with the money depositing and dispensing machine 100. The communication interface 74 is controlled to be driven by the control section 31.

An HDD (Hard Disk Drive) 55 is connected to the bus line 39, which is connected to the CPU 38, via an HDD controller 56. The HDD 55 has, for example, a computer program for causing the control section 31 to operate, a commodity master file, and a sales file that stores sales data and the like stored therein. The commodity master file is a file that stores a commodity name, a unit price, and the like for each commodity. Specifically, the commodity master file stores a commodity name, a unit price, and the like in association with a commodity identification code. The sales file stores sales data and the like. A storage device that stores the computer program, the commodity master file, the sales data, and the like is not limited to the HDD 55. The storage device may be, for example, a CF (Compact Flash (registered trademark)) or an SSD (Solid State Drive). The storage device may be included in the POS terminal 10 or may be an external storage device set on the outside of the POS terminal 10.

The computer program stored in the HDD 55 is written in the RAM 41 together with various files such as the commodity master file during the start of the POS terminal 10 according to the operation of the HDD controller 56. This enables the control section 31 to control to drive the sections.

As shown in FIG. 5, the money depositing and dispensing machine 100 includes a coin depositing and dispensing section 101, a bill depositing and dispensing section 102, and a control section 103. The coin depositing and dispensing section 101 deposits and dispenses coins. The bill depositing and dispensing section 102 deposits and dispenses bills.

The coin depositing and dispensing section 101 includes a coin depositing port 111, a coin sorting mechanism 112, a coin storing section 113, a coin dispensing mechanism 114, and a coin dispensing port 115.

The coin depositing port 111 receives coins. The coin sorting mechanism 112 sorts the coins received by the coin depositing port 111 according to types of the coins. The coin storing section 113 stores the coins sorted by the coin sorting mechanism 112 according to the types of the coins. The coin dispensing mechanism 114 dispenses the coins stored in the coin storing section 113 one by one according to the types of the coins. The coin dispensing port 115 receives the coins dispensed from the coin storing section 113. The coin depositing port 111 and the coin dispensing port 115 are provided in the front (the front section) of a housing 104 of the money depositing and dispensing machine 100.

As shown in FIG. 5, the coin depositing and dispensing section 101 includes a coin depositing sensor 116, a coin storage sensor 117, and a coin dispensing sensor 118. The coin depositing sensor 116 detects that coins are deposited in the coin depositing port 111. The coin storage sensor 117 detects the coins stored in the coin storing section 113 one by one according to types of the coins. The coin dispensing sensor 118 detects the coins dispensed from the coin storing section 113 one by one according to the types of the coins.

The bill depositing and dispensing section 102 includes a bill depositing port 131, a bill sorting mechanism 132, a bill storing section 133, a bill dispensing mechanism 134, and a bill dispensing port 135.

The bill depositing port 131 receives bills. The bill sorting mechanism 132 sorts the bills received by the bill depositing port 131 according to types of the bills. The bill storing section 133 stores the bills sorted by the bill sorting mechanism 132 according to the types of the bills. The bill dispensing mechanism 134 dispenses the bills stored in the bill storing section 133 one by one according to the types of the bills. The bill dispensing port 135 receives the bills dispensed from the bill storing section 133. The bill depositing port 131 and the bill dispensing port 135 are provided in the front (in the front section) of the housing 104 of the money depositing and dispensing machine 100 (see FIG. 1).

The bill depositing and dispensing section 102 includes a bill depositing sensor 136, a bill storage sensor 137, and a bill dispensing sensor 138. The bill depositing sensor 136 detects that bills are deposited in the bill depositing port 131. The bill storage sensor 137 detects the bills stored in the bill storing section 133 one by one according to types of the bills. The bill dispensing sensor 138 detects the bills dispensed from the bill storing section 133 one by one according to the types of the bills.

The control section 103 includes a CPU, an ROM, and an RAM. The coin sorting mechanism 112, the coin dispensing mechanism 114, the coin depositing sensor 116, the coin storage sensor 117, the coin dispensing sensor 118, the bill sorting mechanism 132, the bill dispensing mechanism 134, the bill depositing sensor 136, the bill storage sensor 137, the bill dispensing sensor 138, and the like are connected to the control section 103. A nonvolatile storing section 151 and a communication interface 152 are connected to the control section 103. The storing section 151 rewritably stores various data. The communication interface 152 performs data communication with the POS terminal 10. The storing section 151 rewritably stores stored amount information concerning the balance of money stored by the money depositing and dispensing machine 100. In this embodiment, the stored amount information of money is the numbers of stored coins and bills by type in the coin storing section 113 and the bill storing section 133.

The control section 103 updates the stored amount information stored in the storing section 151 using detection results of the coin depositing sensor 116, the coin storage sensor 117, the coin dispensing sensor 118, the bill depositing sensor 136, the bill storage sensor 137, and the bill dispensing sensor 138.

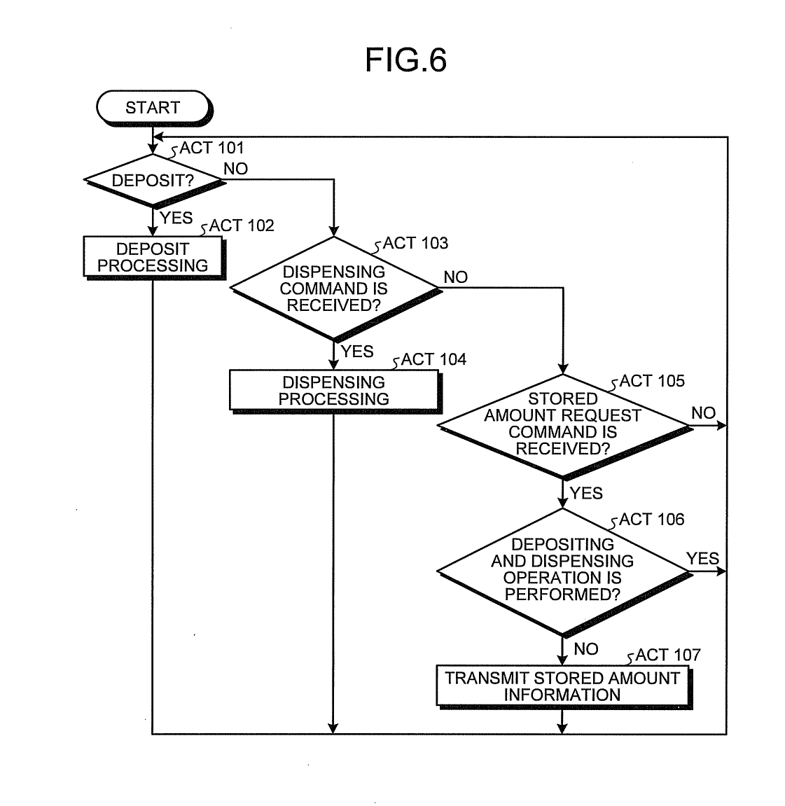

Depositing and dispensing processing performed by the money depositing and dispensing machine 100 is explained below. As shown in FIG. 6, the CPU of the control section 103 of the money depositing and dispensing machine 100 waits for depositing of money, reception of a dispensing command, and reception of a stored amount request command (No in Act 101, No in Act 103, and No in Act 105). If the CPU of the money depositing and dispensing machine 100 determines, from detection results of the coin depositing sensor 116 and the bill depositing sensor 136, that money is deposited (Yes in Act 101), the CPU executes depositing processing (Act 102) In the depositing processing, if the CPU of the money depositing and dispensing machine 100 determines, from the detection result of the coin depositing sensor 116, that money is deposited in the coin depositing port 111, the CPU drives the coin sorting mechanism 112 for a specified time. The specified time is set as time sufficient for coins in the coin depositing port 111 to be stored in the coin storing section 113 according to the operation of the coin sorting mechanism 112 when the coin sorting mechanism 112 operates for the specified time. If the CPU of the money depositing and dispensing machine 100 determines, from the detection result of the bill depositing sensor 136 that money is deposited in the bill depositing port 131, the CPU drives the bill sorting mechanism 132 for a specified time. The specified time is set as time sufficient for bills in the bill depositing port 131 to be stored in the bill storing section 133 according to the operation of the bill sorting mechanism 132 when the bill sorting mechanism 132 operates for the specified time.

If the CPU of the money depositing and dispensing machine 100 receives a dispensing command from the POS terminal 10 (Yes in Act 103), the CPU executes dispensing processing (Act 104). In the dispensing processing, the CPU of the money depositing and dispensing machine 100 drives the coin dispensing mechanism 114 and the bill dispensing mechanism 134 according to the numbers of coins and bills to be dispensed by type included in the dispensing command and causes the coin dispensing mechanism 114 and the bill dispensing mechanism 134 to dispense coins and bills. The CPU of the money depositing and dispensing machine 100 counts detection results of the coin dispensing sensor 118 and the bill dispensing sensor 138. The CPU of the money depositing and dispensing machine 100 continues the driving of the coin dispensing mechanism 114 and the bill dispensing mechanism 134 until money equivalent to the numbers of coins and bills to be dispensed by type included in the dispensing command is dispensed. If the CPU of the money depositing and dispensing machine 100 determines that money equivalent to the numbers of coins and bills to be dispensed by type included in the dispensing command is dispensed, the CPU stops the driving of the coin dispensing mechanism 114 and the bill dispensing mechanism 134.

If the CPU of the money depositing and dispensing machine 100 receives a stored amount request command (Yes in Act 105), if a depositing and dispensing operation is not performed (No in Act 106), the CPU transmits stored amount information according to the stored amount request command (Act 107) Specifically, the CPU of the money depositing and dispensing machine 100 reads out stored amount information (the numbers of stored coins and bills by type) stored in the storing section 151. The CPU of the money depositing and dispensing machine 100 transmits the read-out stored amount information to the POS terminal 10 via the communication interface 152 as stored amount information in the money depositing and dispensing machine 100 at the present point. On the other hand, even if the CPU of the money depositing and dispensing machine 100 receives the stored amount request command (Yes in Act 105), if the depositing and dispensing operation is performed (Yes in Act 106), the CPU does not transmit the stored amount information.

Operations performed when the cash depositing and dispensing system 1 having the configuration explained above is set in a checkout place apart from a commodity selling floor in a store such as a department store are explained. In this case, in the store, operations explained below are carried out as an example. First, in the commodity selling floor, a store clerk calculates, with an electronic calculator or the like, a total amount of commodities that a customer desires to purchase. The store clerk presents the calculated total amount to the customer and receives a deposit from the customer. After moving to the checkout place, the store clerk deposits the entire deposit from the customer in the money depositing and dispensing machine 100. The store clerk performs registration work for the commodities in the POS terminal 10 in parallel to the depositing operation of the money depositing and dispensing machine 100.

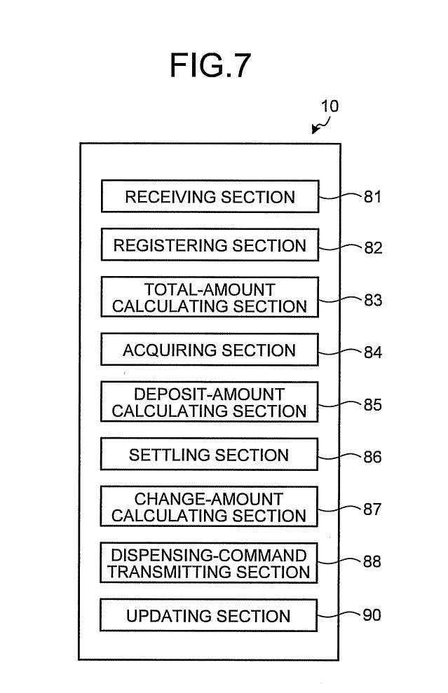

Sales registration processing executed by the CPU 38 of the POS terminal 10 according to a computer program in the registration of the commodities is explained. The CPU 38 of the POS terminal 10 realizes, according to the computer program, as shown in FIG. 7, a receiving section 81, a registering section 82, a total-amount calculating section 83, an acquiring section 84, a deposit-amount calculating section 85, a settling section 86, a change-amount calculating section 87, a dispensing-command transmitting section 88, and an updating section 90 as functional sections.

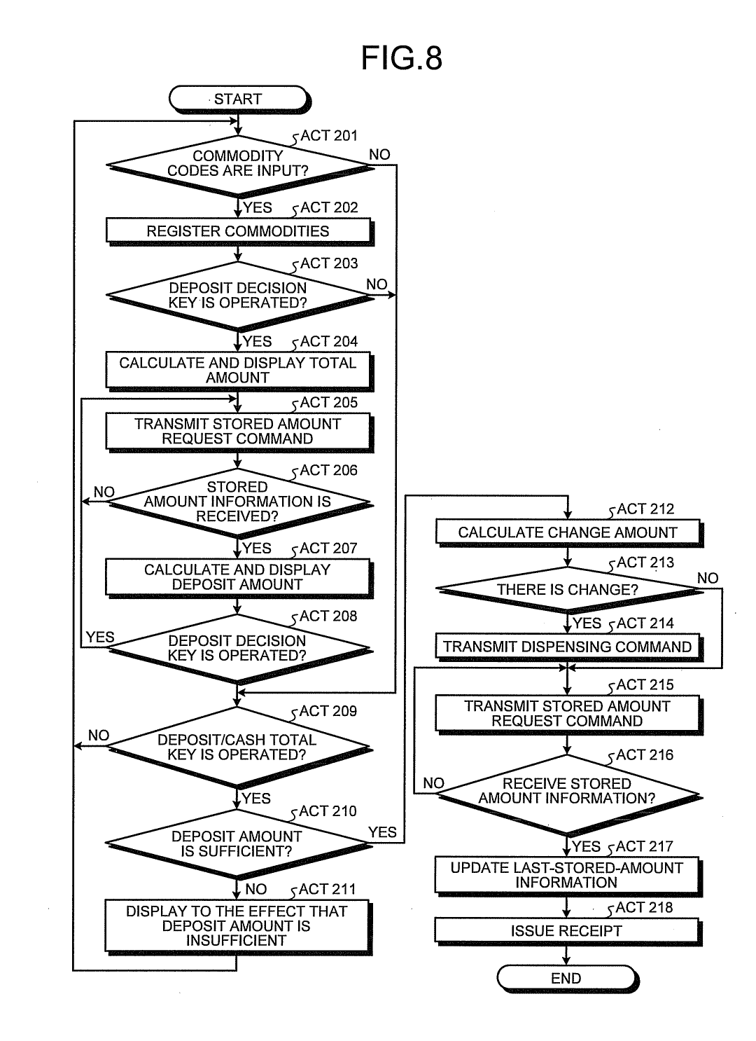

The sales registration processing is explained with reference to FIG. 8. First, the CPU 38 operates as the receiving section 81 and waits for the input of commodity codes, which are identification information, of commodities purchased in one transaction from the code scanner 36 or the keyboard 32 (No in Act 201). The store clerk deposits a deposit from the customer in the money depositing and dispensing machine 100 and performs registration work for the commodities in the POS terminal 10. Depositing timing for the deposit may be any timing as long as the timing is after the decision of the last transaction. The CPU 38 operates as the receiving section 81 and receives the input of commodity codes of commodities purchased in one transaction (Yes in Act 201) Subsequently, the CPU 38 operates as the registering section 82 and registers the commodities, the commodity codes of which are received (Act 202). Specifically, the CPU 38 reads out commodity information of the commodities, the commodity codes of which are received, from the commodity master file. The commodity information includes commodity names and unit prices. The CPU 38 creates sales data of the commodities using the read-out commodity information. The CPU 38 performs sales registration for the commodities by causing the RAM 41 to store the created sales data. The sales data includes the commodity names and the unit prices. The CPU 38 causes the first display 34 and the second display 35 to display the unit prices and the like among the commodity information of the commodities. If the deposit decision key 32d and the deposit/cash total key 32b are not operated (No in Act 203 and No in Act 209), the CPU 38 repeatedly performs the processing in Act 202 every time a new commodity code is input.

If the deposit decision key 32d is operated (Yes in Act 203), the CPU 38 operates as the total-amount calculating section 83 and calculates a total amount of the commodities purchased in one transaction (commodities subjected to sales registration) (Act 204). Specifically, the total-amount calculating section 83 calculates a total amount of the commodities, the input of the commodity codes of which is received by the receiving section 81. The CPU 38 causes the RAM 41 to store the calculated total amount. The CPU 38 causes the first display 34 and the second display 35 to display the calculated total amount.

The CPU 38 operates as the acquiring section 84 and transmits a stored amount request command to the money depositing and dispensing machine 100 (Act 205). The CPU 38 waits for reception of stored amount information from the money depositing and dispensing machine 100 (No in Act 206). The CPU 38 repeatedly transmits the stored amount request command at a specified interval until stored amount information is received (Yes in Act 206). The CPU 38 functioning as the acquiring section 84 transmits the stored amount request command to the money depositing and dispensing machine 100 and receives the stored amount information on condition that the deposit decision key 32d is operated as operation for triggering acquisition of the stored amount information. Before the keyboard 32 receives the operation of the deposit/cash total key 32b, which is operation for triggering settlement, the CPU 38 (the acquiring section 84) transmits the stored amount request command to the money depositing and dispensing machine 100 and receives the stored amount information every time the keyboard 32 receives the operation of the deposit decision key 32d.

If the CPU 38 receives the stored amount information from the money depositing and dispensing machine 100 (Yes in Act 206), the CPU 38 operates as the deposit-amount calculating section 85 and calculates a deposit amount in the money depositing and dispensing machine 100 in the present transaction (Act 207). Specifically, the CPU 38 calculates a present total amount of money in the money depositing and dispensing machine 100 using the received stored amount information. The CPU 38 calculates a total amount of money in the money depositing and dispensing machine 100 at the end of the last transaction on the basis of the last-stored-amount information stored in the RAM 41. The CPU 38 subtracts the total amount of money in the money depositing and dispensing machine 100 at the end of the last transaction from the present total amount of money in the money depositing and dispensing machine 100 to calculate a deposit amount in the money depositing and dispensing machine 100 in the present transaction. The CPU 38 causes the RAM 41 to store the calculated deposit amount. The CPU 38 causes the first display 34 and the second display 35 to display the calculated deposit amount.

The CPU 38 waits for the deposit decision key 32d and the deposit/cash total key 32b to be operated (No in Act 208 and No in Act 209). If the deposit decision key 32d is operated again (Yes in Act 208), the CPU 38 repeatedly performs the processing in Act 205 to Act 207. In this case, in Act 207, the CPU 38 updates the deposit amount stored in the RAM 41. Specifically, before the keyboard 32 receives the operation of the deposit/cash total key 32b, every time the keyboard 32 receives the operation of the deposit decision key 32d, the CPU 38 (the acquiring section 84) transmits the stored amount request command to the money depositing and dispensing machine 100 and receives the stored amount information from the money depositing and dispensing machine 100.

After Act 207, if the deposit/cash total key 32b is operated (Yes in Act 209), the CPU 38 operates as the settling section 86 and determines whether the deposit amount calculated in Act 207 is sufficient as payment (Act 210). If the CPU 38 determines that the deposit amount calculated in Act 207 is sufficient as the payment (Yes in Act 210), the CPU 38 proceeds to Act 212 and performs settlement of one transaction with the deposit amount. In the determination concerning whether the deposit amount is sufficient for the payment, the CPU 38 determines whether the deposit amount calculated in Act 207 is equal to or larger than the total amount calculated in Act 204. If the deposit amount is equal to or larger than the total amount, the CPU 38 determines that the deposit amount is sufficient as the payment. If the deposit amount is smaller than the total amount, the CPU 38 determines that the deposit amount is insufficient as the payment. The processing in the settlement includes calculation of a change amount and issuance of a receipt in the following processing. In this way, the CPU 38 (the settling section 86) performs the settlement on condition that the keyboard 32 receives the operation of the deposit/cash total key 32b. If the deposit amount is insufficient as the payment (No in Act 210), the CPU 38 proceeds to Act 211.

In Act 211, the CPU 38 causes the first display 34 to display to the effect that the deposit amount is insufficient.

On the other hand, if the CPU 38 proceeds to Act 212, the CPU 38 operates as the change-amount calculating section 87 and calculates a change amount using the deposit amount and the total amount (Act 212). The CPU 38 calculates a change amount by subtracting the total amount of the commodities of the present transaction calculated in Act 204 and stored in the RAM 41 from the deposit amount stored in the RAM 41 in Act 207. The CPU 38 outputs the calculated change amount. Specifically, the CPU 38 causes the first display 34 and the second display 35 to display the calculated change amount.

If there is change (Yes in Act 213), the CPU 38 operates as the dispensing-command transmitting section 88 and transmits a dispensing command for instructing dispensing of money equivalent to the calculated change amount to the money depositing and dispensing machine 100 (Act 214) and proceeds to Act 215. On the other hand, if there is no change (No in Act 213), the CPU 38 proceeds to Act 215 without transmitting the dispensing command.

In Act 215, the CPU 38 operates as the updating section 90, transmits a stored amount request command to the money depositing and dispensing machine 100, and waits for stored amount information to be received from the money depositing and dispensing machine 100 (No in Act 216). The CPU 38 repeatedly transmits the stored amount request command at a specified interval until the stored amount information is received (Yes in Act 216). In other words, if the stored amount information cannot be received within the specified time after the request information is transmitted, the CPU 38 (the updating section 90) transmits the request information again.

If the CPU 38 (the updating section 90) receives the stored amount information from the money depositing and dispensing machine 100 (Yes in Act 216), the CPU 38 updates the last-stored-amount information (Act 217). The CPU 38 updates the last-stored-amount information by causing the RAM 41 to overwrite and store the received stored amount information in the last-stored-amount-information storing area 41a of the RAM 41 as the last-stored-amount information. In this way, the CPU 38 functioning as the updating section 90 acquires the stored amount information of the money depositing and dispensing machine 100 at the end of the present transaction and causes the RAM 41 (the storing section) to store the stored amount information as the last-stored-amount information. After operating as the dispensing-command transmitting section 88 and transmitting the dispensing command to the money depositing and dispensing machine 100, the CPU 38 (the updating section 90) transmits a stored-amount request command and receives stored amount information. If there is no change, the stored amount information received in Act 206 according to the transmission of the stored-amount request command in Act 205 is the same as the stored amount information of the money depositing and dispensing machine 100 at the end of the present transaction. Therefore, the CPU 38 may cause the RAM 41 functioning as the storing section to store the stored amount information received in Act 206 as the last-stored-amount information. In this case, if there is no change, the CPU 38 does not have to perform the processing in Acts 215 and 216.

The CPU 38 causes the thermal printer 37 to print and issue a receipt (Act 218). On the receipt, the names, the unit prices, the total amount, the deposit amount, the change amount, and the like of the commodities purchased in one transaction are printed. The CPU 38 functions as a change-amount calculating section configured to output the calculated change amount to the receipt.

As explained above, with the POS terminal 10 according to this embodiment, the store clerk can perform input work for commodity codes in parallel to the depositing operation of the money depositing and dispensing machine 100 in one transaction. With the POS terminal 10 according to this embodiment, it is possible to provide an environment in which a reduction in time required for one transaction can be realized.

The present invention is not limited to the embodiments. Various other embodiments can be adopted without departing from the spirit of the present invention. For example, the commodity sales data processing apparatus may be applied to an ECR (Electric Cash Register).

The computer programs executed by the POS terminal 10 and the money depositing and dispensing machine 100 according to this embodiment may be provided while being recorded in a computer-readable recording medium such as a CD-ROM, a flexible disk (FD), a CD-R, or a DVD as a file of an installable format or an executable format.

The computer programs executed by the POS terminal 10 and the money depositing and dispensing machine 100 according to this embodiment may be provided while being stored on a computer connected to a network such as the Internet and downloaded through the network. The computer programs executed by the POS terminal 10 and the money depositing and dispensing machine 100 according to this embodiment may be provided or distributed through the network such as the Internet.

As explained above, according to the embodiments, it is possible to provide an environment in which a reduction in time required for a transaction can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing apparatus comprising:
an acquiring section configured to acquire stored amount information concerning a total amount of money stored in a money depositing and dispensing machine;
a storing section configured to store last-stored-amount information concerning a total amount of money in the money depositing and dispensing machine after an end of a last transaction; and
a deposit-amount calculating section configured to calculate a deposit amount in a present transaction using the last-stored-amount information stored by the storing section and the stored amount information acquired by the acquiring section.

2. The apparatus according to claim 1, further comprising an operation section configured to receive operation for triggering acquisition of the stored amount information, wherein
the acquiring section transmits, on condition that the operation section receives the operation for triggering acquisition of the stored amount information, request information for requesting the stored amount information to the money depositing and dispensing machine and receives the stored amount information from the money depositing and dispensing machine.

3. The apparatus according to claim 1, further comprising an updating section configured to acquire the stored amount information of the money depositing and dispensing machine at the end of the present transaction and cause the storing section to store the stored amount information as the last-store-amount information.

4. The apparatus according to claim 3, further comprising:
a change-amount calculating section configured to calculate a change amount using the deposit amount and a total amount of commodities; and
an output-command transmitting section configured to transmit a dispensing command for instructing dispensing of money equivalent to the change amount to the money depositing and dispensing machine, wherein
if there is change, after the dispensing command is transmitted to the money depositing and dispensing machine by the dispensing-command transmitting section, the updating section transmits the request information, receives the stored amount information, and causes the storing section to store the stored amount information as the last-stored-amount information.

5. The apparatus according to claim 4, wherein, if there is no change, the updating section transmits the request information, receives the stored amount information, and causes the storing section to store the stored amount information as the last-stored-amount information.

6. The apparatus according to claim 4, wherein the updating section transmits the request information again if the updating section cannot receive the stored amount information within a specified time after the request information is transmitted.

7. The apparatus according to claim 2, further comprising a settling section configured to determine whether the deposit amount is equal to or larger than the total amount of the commodities and perform settlement of one transaction with the deposit amount if it is determined that he deposit amount is equal or larger than the total amount of the commodities, wherein
the operation section receives operation for triggering the settlement,
the settling section performs the settlement on condition that the operation section receives the operation for triggering the settlement, and
before the operation section receives the operation for triggering the settlement, every time the operation section receives the operation for triggering the acquisition of the stored amount information, the acquiring section transmits the request information to the money depositing and dispensing machine and receives the stored amount information.

8. The apparatus according to claim 1, further comprising:
a receiving section configured to receive input of identification information of commodities purchased in one transaction;
a total-amount calculating section configured to calculate a total amount of the commodities purchased in one transaction, the input of the identification information of which is received; and
a change-amount calculating section configured to calculate a change amount using the deposit amount and the total amount of the commodities and output the calculated change amount.

9. A cash depositing and dispensing system comprising:
a money depositing and dispensing machine; and
the commodity sales data processing apparatus according to claim 1.

10. A data processing method comprising:
an acquiring section acquiring stored amount information concerning a total amount of money stored in a money depositing and dispensing machine; and
a deposit-amount calculating section calculating a deposit amount in a present transaction using last-stored-amount information concerning a total amount of money in the money depositing and dispensing machine after an end of a last transaction and the stored amount information acquired by the acquiring section, the last-stored-amount information being stored by a storing section.
